(19) United States
(12) Patent Application Publication
(10) Pub. No.: US 2021/0353118 A1
(43) Pub. Date: Nov. 18, 2021

(54) SUCTION-ADHERING AND SELF-PROPELLED ROBOTIC DEVICE

(71) Applicant: URAKAMI LLC, Kanagawa (JP)

(72) Inventor: Fukashi URAKAMI, Kanagawa (JP)

(21) Appl. No.: 17/305,320

(22) Filed: Jul. 5, 2021

Related U.S. Application Data
(63) Continuation of application No. PCT/JP2019/048169, filed on Dec. 9, 2019.

(30) Foreign Application Priority Data
Jan. 7, 2019 (JP) 2019-000796

(51) Int. Cl. A47L 1/02; B08B 3/02; B08B 13/00; B08B 1/00; B62D 57/032

(52) U.S. Cl. CPC A47L 1/02; B08B 3/024; B62D 57/032; B08B 1/005; B08B 1/008; B08B 13/00

(57) ABSTRACT

A robotic device is equipped with four suction cup units, Y-axis actuators and X-axis actuators. As for the planar shape of each suction cup, it has a shape of each quadrangle when a roughly square was divided into four quadrangles of the same shape. The quadrangles are formed provided with two right-angle portions in a diagonal portion. One right angle of the two right-angle portions of each suction cup overlaps with one of the four right angles of the square. Two of the sides that constitute the above right angle of the suction cup overlap with two of the edges that constitute the above right angle of the square. One of the sides that constitute another right angle of the suction cup intersects to an acute angle in one side of the right angle of the square, and another side intersects to an obtuse angle in another side of the right angle of the square.

### CROSS-REFERENCE TO RELATED APPLICATIONS

This is a continuation application of a prior PCT application No. PCT/JP/2019/048169 filed on Dec. 9, 2019.

### TECHNICAL FIELD

The present invention relates to a robotic device which performs adhering to by vacuum and travelling on a surface of the object, or relates to a robotic device which performs adhering to by vacuum and travelling on a surface of the object while cleaning the surface such as window glass of a building.

The present invention also relates to a cleaning method and program to be executed by the robotic device, and a computer-readable recording medium in which the computer program is stored.

### BACKGROUND OF THE INVENTION

Japanese Laid-Open Patent Publication No. 5-42063 proposes a device which adheres to a surface and can be moved along the surface including: four sets of the vertical telescopic means that can move perpendicular to the surface; horizontal telescopic means that can move in a direction parallel to the surface that is mounted on each of the vertical telescopic means; suction cup units mounted on each of the horizontal telescopic means; vertical protrude/retract means mounted between the suction cup unit and the horizontal telescopic mean; wherein the device being characterized in that each of the suction cup units is selectively set at least in the following three states:
(1) the adsorption movable state in which the suction cup unit can be moved along the surface and in close contact with the surface;
(2) the adsorption lock state in which the suction cup unit is adsorbed and locked on the surface;
(3) the non-adsorption movable state in which the suction cup unit is separated from the surface and can be moved along the surface.

In the above-described device, the device can adhere to the surface of the object and can travel along the surface in which, in the case where a protruding bar such as a window glass frame exists on the surface, and when the protruding bar extends in the horizontal direction and the vertical direction and has a number of crossing portions, the device can travel by stepping over the protruding bar in either of the horizontal direction or the vertical direction.

Japanese Laid-Open Patent Publication No. 2012-6116 proposes “a cleaning device for window glass or the like”, wherein, in three suction cup units which are arranged in a row, each of the suction cup units includes the vertical protrude/retract means of the suction cup unit for putting the suction cup unit in the direction intersecting with the surface of the object, the suction cup units adjacent to each other are coupled by the lateral wise horizontal telescopic means via the vertical protrude/retract means of the suction cup unit, when the three suction cup units coupled by the lateral wise horizontal telescopic means via the vertical protrude/retract means of the suction cup unit are referred to a row suction cup group, three row suction cup groups are arranged in the longitudinal direction, the row suction cup groups adjacent to each other are coupled by the lengthwise horizontal telescopic means via the vertical protrude/retract means of the suction cup unit, each of the suction cup units can be selectively set in either one of the following three states:
(1) the adsorption movable state in which the suction cup unit can be moved along the surface and in close contact with the surface;
(2) the adsorption lock state in which the suction cup unit is adsorbed and locked on the surface;
(3) the non-adsorption movable state in which the suction cup unit is separated from the surface and can be moved along the surface;
   each of the suction cup units is constituted at least by a suction cup frame member, a vacuum sealing member attached to the suction cup, moving means, and locking means, and at least the surface, the suction cup frame member, and the vacuum sealing member define a reduced pressure space in cooperation, the reduced pressure space being coupled to vacuum generating means and vacuum breaking means.

In the above-described device, the device can step over a window frame in a horizontal direction or a vertical direction when there are many window frames that extend to a horizontal direction and both vertical directions and intersect on the surface of the object.

Patent Reference 1: Japanese Laid-Open Patent Publication No. 5-42063

Patent Reference 2: Japanese Laid-Open Patent Publication No. 2012-6116

### SUMMARY OF THE INVENTION

In the conventional method to clean the dirt which attached to the smooth surface of the object such as window glass, at first a cleaning agent is sprayed to the surface of the object or the surface of the object is got wet by a sponge with a cleaning agent, in the next step the dirt with the cleaning agent is scraped off by a handheld tool with the rubber blade named “squeegee”.

The free end of the vacuum sealing member of the present invention has the same function as the free end of the rubber blade of the squeegee that scrapes off the dirt and the cleaning agent.

Furthermore the suction cup of the present invention has also a function to adhere to the surface of the object in addition to the function that scrapes off the dirt and the cleaning agent.

Therefore, as for the cross-sectional shape of the vacuum sealing member that is cut at a parallel plane by the surface, the cross-sectional shape has not a shape of a linear such as the rubber blade of the squeegee but has a shape of an annular quadrangle that is surrounded by the free end of the vacuum sealing member.

Describes the arrangement of four suction cup units, there is placed in one line on X-axis the suction cup group that is comprised of two suction cup units that is located to be next each other, there is placed in one line on X-axis the other suction cup group that is comprised of two suction cup units that is located to be next each other, there are placed the two suction cup groups that are located in two lines on Y-axis to be next each other.

It may happen the problem that the dirt and the cleaning agent is not scrapped off completely if there is a gap between two suction cup units located to be next when the suction cup groups move to clean the window glass on the surface of the object.

As for the major theme to be solved by the present invention, it should be researched what is the most suitable shape of each suction cup and what is the most suitable shape of each suction cup group in order to realize the most suitable method for the complete window glass cleaning without the remained the dirt and the cleaning agent.

In the present invention, the following consideration is carried out and a solution is suggested as follows in order to solve the problem above mentioned.

As for the shape of the window glass of the large buildings in general, it is the shape of the rectangular parallelepiped with the right angle in 4 corners.

Therefore, it is desirable for the shape of the outside corner part of the suction cup to be a right angle that comes in contact with the corner part of the window glass in order to scrape off the dirt and the cleaning agent on the window glass.

As for the relation of the arrangement between the suction cup units next to each other on the X-axis;

as for the relation of the arrangement between the outside vicinity that is on the X-axis and constitutes a right angle of a suction cup and the other outside vicinity that is on the same X-axis and constitutes the other right angle of the other suction cup, the two vicinities should be on the same X-axis in order to scrape off the dirt and the cleaning agent on the window glass at a corner part nearly a window frame.

Considering about the angle that is constructed by the diagonal side of one suction cup and X-axis, and considering about the angle that is constructed by the diagonal side of the other suction cup and X-axis, and considering about that the diagonal side of one suction cup and the diagonal side of the other suction cup are parallel and next to each other, and considering from the standpoint that the dirt and the cleaning agent should not be remained on the surface of the object; it is desirable for the angle that the diagonal side and X-axis of one suction cup intersect to be an acute angle, and it is desirable for the angle that the diagonal side and X-axis of the other suction cup intersect to be an obtuse angle.

By the above-mentioned consideration, it is concluded that the desirable planar shape of each suction cup should be the quadrangle with two right angles at the opposite angle.

As for the relation of the arrangement between the suction cup units next to each other on the Y-axis;

as for the relation of the arrangement between the outside vicinity that is on the Y-axis and constitutes a right angle of a suction cup and the other outside vicinity that is on the same Y-axis and constitutes the other right angle of the other suction cup, the two vicinities should be on the same Y-axis in order to scrape off the dirt and the cleaning agent on the window glass at a corner part nearly a window frame.

Considering about the angle that is constructed by the diagonal side of one suction cup and Y-axis, and considering about the angle that is constructed by the diagonal side of the other suction cup and Y-axis, and considering about that the diagonal side of one suction cup and the diagonal side of the other suction cup are parallel and next to each other, and considering from the standpoint that the dirt and the cleaning agent should not be remained on the surface of the object; it is desirable for the angle that the diagonal side and Y-axis of one suction cup intersect to be an acute angle, and it is desirable for the angle that the diagonal side and Y-axis of the other suction cup intersect to be an obtuse angle.

By the above-mentioned consideration, it is concluded that the desirable planar shape of each suction cup should be the quadrangle with two right angles at the opposite angle.

In conclusion, when one suction cup group is formed by assembling the four suction cup units of the same planar shape equipped with the above conditions, the shape of the outside of the suction cup group is a square, and the acute angle of each suction cup is about 63 degrees.

The purpose of this invention is to provide a suction-adhering and self-propelled robotic device that can drive itself along the surface of the object in any direction, either in the Y-axis or the X-axis, and that can perform cleaning work without leaving any dirt or water on the surface of the object, such as window glass.

In order to achieve such an objective, the invention employs a means to ensure that when four suction cup units of the same flat shape are assembled to form a single suction cup group, the outer shape of the suction cup group is square.

The suction-adhering and self-propelled robotic device of the present invention, by adopting the above means, pursues the improvement of the functions of the device itself, which ultimately contributes to the downsizing and weight reduction of the device.

Therefore, the manufacturing and maintenance costs of the device are reduced, and the high quality work can be performed in either the X-axis or Y-axis direction without leaving any dirt behind. This has various beneficial effects, such as improved work efficiency, improved workability due to improved portability and storability of the device, improved versatility by expanding the range of applicability of the device, and improved aesthetic value in terms of the design of the device.

FIG. 6 and FIG. 7 are schematic views in which there are two types of the suction cup group. Each suction cup group has a square outer shape that is formed by assembling four suction cup units having the same planar shape.

As understood from the schematic view of FIG. 7, there is a gap between the adjacent suction cup units, but the suction cup group moves along the surface of the object while moving in the direction of the X-axis and the Y-axis while cleaning, it is possible to carry out the cleaning work without leaving dirt and water stuck to the surface of the object.

In order to solve the technical problems described in the above, the suction-adhering and self-propelled robotic device of the present invention is specifically configured as follows.

The suction-adhering and self-propelled robotic device that can adhere to the flat or curved surface of the object such as window glass by negative-pressure suction and that can travel in the Y-axis direction and the X-axis direction.

The robotic device is equipped with at least four suction cup units that are arranged in two rows, two on the X-axis and two on the Y-axis, and is equipped with the Y-axis actuator to move each suction cup unit in the Y-axis direction and the X-axis actuator to move each suction cup unit in the X-axis direction.

The suction cup unit is equipped with a suction cup, a frictional force adjustment mechanism that is equipped with the suction cup in order to decrease or to increase the friction between the suction cup and the surface of the object, and a fluid extraction means that is communicated with and extracts the fluid from a negative-pressure space that is surrounded by the suction cup and the surface of the object.

The suction cup is comprised of a suction cup frame member and a vacuum sealing member that is put on in the outer peripheral portion of the suction cup frame member.

The frictional force adjustment mechanism nay be comprised of a mechanism wherein the frictional force between the suction cup and the surface of the object is decreased by means to push strongly a slippery material such as a roller to the surface of the object;

or the frictional force adjustment mechanism may be comprised of another mechanism wherein the frictional force between the suction cup and the surface of the object is decreased by means to decrease the pressure of a negative-pressure space that is surrounded by the suction cup and the surface of the object.

As for the planar shape of each suction cup, it has a shape same as each quadrangle when a roughly square was divided into four quadrangles of the same shape except the small square part of the center;

the quadrangles are formed provided with two right-angle portions in a diagonal portion;

one right angle of the two right-angle portions of each suction cup overlaps with one of the four right angles of the square;

two of the sides that constitute the above right angle of the suction cup overlap with two of the edges that constitute the above right angle of the square;

one of the sides that constitute another right angle of the suction cup intersects to an acute angle in one side of the right angle of the square, and another side intersects to an obtuse angle in another side of the right angle of the square;

a suction-adhering and self-propelled robotic device, wherein an angle of the acute angle is almost approximately 63 degrees.

In the suction-adhering and self-propelled robot device according to the present invention, each of the Y-axis actuators and the X-axis actuators is configured by the rod-less cylinder, and each rod-less cylinder is configured as follows.

Both ends of the cylinder of the rod-less cylinder are closed with end caps, and two pistons that reciprocate in the cylinder by fluid pressure are arranged inside the cylinder, and the space surrounded by the two pistons and the inner wall of the cylinder is connected to the fluid supply/exhaust port provided in the end cap via coiling tube arranged in the cylinder.

In the suction-adhering and self-propelled robotic device of the present invention comprises the suction-adhering and self-propelled function that can adhere to the surface of the object such as window glass by negative-pressure suction and that can travel in the Y-axis direction and the X-axis direction, furthermore, the robotic device may comprise the function that can travel across a windowpane frame, wherein:

The suction cup Z-axis protrude/retract actuator for moving each of the suction cup units in the Z-axis direction crossing the surface of the object, so that the suction cup has a function of separating the suction cup from the surface of the object when the suction cup is needed to be set apart from the surface of the object.

In the suction-adhering and self-propelled robotic device of the present invention, furthermore, the robotic device comprises the function that can prevent scattering of the dirt and the water on the surface of the object such as window glass after being scraped the dirt and the water, wherein:

the suction-adhering and self-propelled robotic device, wherein a second suction cup is formed at the outer peripheral portion of each suction cup, wherein the second suction cup is comprised of a second suction cup frame member fixed at the outer peripheral portion of the suction cup frame member, wherein the second suction cup is also comprised of a second vacuum sealing member that is put on in the outer peripheral portion of the second suction cup frame member, wherein it is formed the second negative-pressure space that is surrounded by the suction cup frame member, the vacuum sealing member, the second suction cup frame member, the second vacuum sealing member and the surface of the object, wherein the second negative-pressure space is communicated with a second fluid extraction means that extracts the fluid from the second negative-pressure space, wherein a fluid jetting nozzle may be equipped with the second negative-pressure space, wherein the fluid such as water or cleaning agent is ejected toward the surface of the object from the fluid jetting nozzle.

The suction-adhering and self-propelled robotic device of the present invention is capable of negative-pressure adsorption on a flat or curved surface of the object, and self-propelled in any direction along the surface of the object, either in the Y-axis direction or the X-axis direction.

The suction-adhering and self-propelled robotic device is equipped with a total of four suction cup units, two on the X-axis and two in a row on the Y-axis. The suction cup units are equipped with an X-axis actuator to move them along the

X-axis and a Y-axis actuator to move them along the Y-axis, respectively.

Each of the Y-axis actuator and the X-axis actuator consists of a rod-less cylinder. Each rod-less cylinder is sealed at both ends with end caps, and inside the cylinder are two pistons that move back and forth inside the cylinder by fluid pressure.

The space enclosed by the two pistons and the inner wall of the cylinder is connected to the ports for supply and exhaust on the end cap via coiling tubes located in the cylinder.

The suction cup unit consists of a suction cup and a suction cup friction force adjustment mechanism to adjust the friction force between the suction cup and the surface of the object.

The suction cup units are composed of a suction cup frame member and a suction cup seal member attached to the outer periphery of the suction cup frame member. Each of the suction cup units is in the shape of an abbreviated plane, with one diagonal portion having two short right angles and the other diagonal portion having an acute angle and an obtuse angle.

The four suction cup units, each of which has a rectangular shape, can be arranged in such a way that when the four suction cup units are arranged, the overall shape is one rectangular square (FIG. 1, FIG. 2, FIG. 7, FIG. 10).

The cleaning process of the surface of the object performed by the suction-adhering and self-propelled robotic device is described below.

Step 1 is a cleaning process in which two suction cup units arranged in the Y-axis are released from their locked state and moved along the X-axis, and when they reach a predetermined position, the two suction cup units are put into their locked state;

Step 2 is a cleaning process in which the two suction cup units located on the other Y axis are released from their locked state and moved along the X axis, and when the two suction cup units located on the Y axis and the two suction cup units located on the other Y axis form a single square, the two suction cup units are put into their locked state;

Step 3 is a cleaning process in which the outer frame of the suction-adhering and self-propelled robotic device is moved along the X-axis to the two suction cup units in the locked state located in the other Y-axis;

The suction-adhering and self-propelled robotic device can perform a cleaning process that includes the three cleaning processes described above, namely step 1, step 2, and step 3.

Regarding the “moving along the X-axis” operation in the cleaning process of Step 1 and Step 2 above, the device may be moved along the X-axis toward the forward direction or in the opposite direction of the forward direction.

The cleaning process of step 1 to step 3 can be repeated as many times as necessary.

The cleaning process of the surface of the object performed by the suction-adhering and self-propelled robotic device is further described below.

Step 4 is a cleaning process in which two suction cup units arranged in the X-axis are moved along the Y-axis with the suction cup units released from their locked state, and when they reach a predetermined position, the two suction cup units are put into their locked state;

Step 5 is a cleaning process in which the two suction cup units located on the other X axis are released from their locked state and moved along the Y axis, and when the two suction cup units located on the Y axis and the two suction cup units located on the other Y axis form a single square, the two suction cup units are put into their locked state;

Step 6 is a cleaning process in which the outer frame of the suction-adhering and self-propelled robot device is moved along the Y-axis to the two suction cup units in the locked state located on the other X-axis;

The suction-adhering and self-propelled robotic device can perform a cleaning process that includes the three cleaning processes described above, namely step 4, step 5, and step 6.

The cleaning process of step 4 to step 5 or step 4 to step 6 can be repeated as many times as necessary.

Each of the suction cup units is further equipped with the suction cup Z-axis protrude/retract actuator for moving the suction cup unit in the Z-axis direction intersecting the surface of the object, i.e., the suction cup unit is released from the locked state or is made to be locked by the Z-axis actuator being operated in the Z-axis direction. In other words, each of the suction cup units is equipped with a suction cup friction force adjustment mechanism.

For example, a ball roller may be provided as a component of the suction cup friction force adjustment mechanism, and when the ball roller is protruded, the suction cup is released from the locked state, and when the ball roller is retracted, the suction cup is in the locked state.

The suction-adhering and self-propelled robotic device may be further equipped with a means for collecting dirt and water peeled off from the surface of the object scraped off by the free end of the suction cup sealing member, and a second suction cup may be placed on the outer periphery of each of the suction cup units to prevent the dirt and water from scattering around the robotic device. The second suction cup may be placed on the outer periphery of each of the suction cup units in order to prevent dirt and water from splashing around the robot device.

In the method of cleaning the surface of the object performed by the suction-adhering and self-propelled robotic device of the present invention, the cleaning process may comprise at least one or more of the cleaning processes comprising step 1, step 2, step 3, step 4, step 5, and step 6 described above.

A computer program executed by the suction-adhering and self-propelled robotic device according to the present invention, which is equipped with a memory and a processor for executing the program, wherein the memory stores a computer program to perform a method for cleaning the surface of the object, including at least one or more of the cleaning processes comprising step 1, step 2, step 3, step 4, step 5, and step 6 described above. The cleaning method is realized when the program is executed by the processor.

Effects of the present invention will be explained below. The present invention is to provide the suction-adhering and self-propelled robotic device having the features as follows.

The present invention contributes to making the device compact and lightweight, reducing the manufacturing cost and maintenance cost of the device, without leaving dirt in both the X axis direction and the Y axis direction.

It is possible to perform high-quality work without the above-mentioned problems, it is possible to improve work efficiency, improve workability by improving the portability and storageability of the device, expand the applicable range of the device, improve versatility, improvement of the aesthetic value on the surface, and the like.

FIG. 6 and FIG. 7 are schematic views in which there are two types of the suction cup group. Each suction cup group has a square outer shape that is formed by assembling four suction cup units having the same planar shape.

As understood from the schematic view of FIG. 7, there is a gap between the adjacent suction cup units, but the suction cup group moves along the surface of the object while moving in the direction of the X-axis and the Y-axis while cleaning, it is possible to carry out the cleaning work without leaving dirt and water stuck to the surface of the object.

### BRIEF DESCRIPTION OF THE DRAWINGS

FIG. 1 is a front view of a first preferred embodiment of the device constructed in accordance with the present invention;

FIG. 2 is a rear view of the device shown in FIG. 1 as seen from the direction of the surface of the object;

FIG. 3 is a right side view of the device shown in FIG. 1;

FIG. 4 is a cross-sectional view of the device shown in FIG. 1 taken along the line A-A, showing a state in which the ball roller 68 is retracted;

FIG. 5 is a cross-sectional view of the device shown in FIG. 1 taken along the line A-A, showing a state in which the ball roller 68 protrudes;

FIG. 6 is a first schematic view of a suction cup group provided in the device shown in FIG. 1;

FIG. 7 is a second schematic view of a suction cup group provided in the device shown in FIG. 1;

FIG. 8 is a time-series diagram showing a procedure in which the device shown in FIG. 1 performs cleaning on the surface of the object 1 while suction-adhering is performed on the surface of the object 1 and moving from left to right along the surface of the object 1, then moving from top to bottom, then moving from right to left, then moving from top to bottom, and then moving from left to right.

FIG. 9 is a front view of a second preferred embodiment of the device constructed in accordance with the present invention;

FIG. 10 is a rear view of the device shown in FIG. 9 as seen from the direction of the surface of the object;

FIG. 11 is a right side view of the device shown in FIG. 9;

FIG. 12 is a cross-sectional view of the device shown in FIG. 9 taken along the line B-B, showing a state in which the ball roller 68 is retracted;

FIG. 13 is an enlarged cross-sectional view showing a state in which the suction cup Z-axis moving cylinder 8 is provided in the device shown in FIGS. 9 to 12.

FIG. 14 is a cross-sectional view of the B-B arrow view in the apparatus shown in FIG. 15, showing the apparatus configuration of a suitable example of an apparatus configured according to the present invention.

FIG. 15 is a cross-sectional view of the A-A arrow in the device shown in FIG. 14.

FIGS. 16(A), 16(B) and 16(C) show three different ways of supplying compressed air to the device shown in FIGS. 14 and 15.

### DETAILED DESCRIPTIONS OF THE PREFERRED EMBODIMENTS

Preferred embodiments of the device configured according to the present invention will be described in detail below, referring to the figures attached hereto.

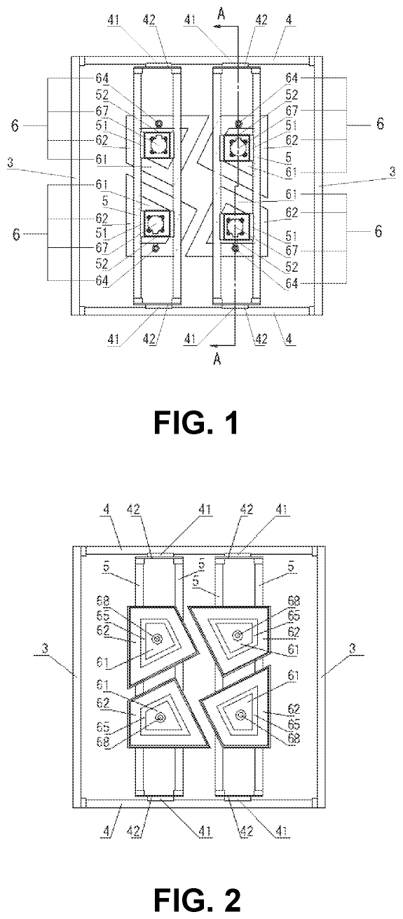

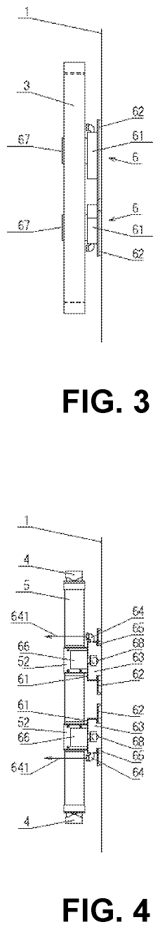

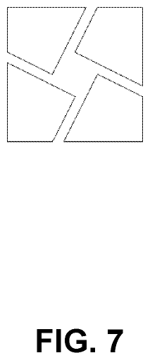

In FIG. 1 to FIG. 8, the first embodiment of the present invention will be explained. FIG. 1 illustrates a front view of the device of the present invention under suction-adhering to a vertical surface of the object 1.

In FIG. 1, the vertical direction is the actual vertical direction and is referred to as the Y-axis direction.

In FIG. 1, the left-right direction is the actual horizontal direction and is referred to as the X-axis direction.

In the present specification, a direction orthogonal to the surface of the object 1 is referred to as the Z-axis direction, a direction approaching the surface of the object 1 is referred to as a front side, and a direction away from the surface of the object 1 is referred to as a back side.

In a robotic device capable of self-propulsion in an appointed direction in either the Y-axis direction or the X-axis direction along the surface of the object 1 by suction-adhering to the surface of the object 1 such as a window glass, furthermore, in a robotic device capable of self-propulsion in the appointed direction without the operation for the device to be rotated in parallel to the surface of the object 1, comprising:

the robotic device illustrated is equipped with at least four suction cup units that are arranged in two rows with two units in a row respectively, Y-axis actuators that move each suction cup unit to the Y-axis direction and X-axis actuators that move each suction cup unit to the X-axis direction.

The suction cup unit is equipped with a suction cup 6, a suction cup friction force adjustment mechanism for adjusting the friction force between the suction cup 6 and the surface of the object 1, and a fluid extraction mechanism. The suction cup friction force adjustment mechanism is provided on the suction cup 6, and the friction force between the suction cup 6 and the surface of the object 1 can be decreased or increased as desired.

The fluid extraction mechanism is connected to the first negative pressure space in order to extract the fluid from the first negative pressure space surrounded by the suction cup 6 and the surface of the object 1.

the suction cup 6 is comprised of a suction cup frame member 61 and a vacuum sealing member 62 that is put on in the outer peripheral portion of the suction cup frame member 61;

The suction cup frame member 61 has a box shape opened in a direction facing the surface of the object 1, and a quadrangular annular suction cup seal member 62 formed from a flexible material such as polyurethane is fixed to a flange portion located in the opened portion of the suction cup frame member 61, and a quadrangular annular locking member 65 made of a material having a large friction coefficient such as rubber is fixed to the flange portion.

The free end portion of the suction cup seal member 62 moves while contacting the surface of the object 1 to clean the surface of the object 1.

The surface of the object 1, the suction cup frame member 61, and the suction cup seal member 62 cooperate with each other to define a suction cup negative pressure space 63, and the suction cup negative pressure space 63 is communicated with a suction generating means (not shown) via a suction hose 641.

the frictional force adjustment mechanism is comprised of a mechanism wherein the frictional force between the suction cup 6 and the surface of the object 1 is decreased by means to push strongly a slippery material such as a roller to the surface of the object 1;

or the frictional force adjustment mechanism is comprised of another mechanism wherein the frictional force between the suction cup 6 and the surface of the object 1 is decreased by means to decrease the pressure of a negative-pressure space that is surrounded by the suction cup 6 and the surface of the object 1;

Each of the suction cup units has a Z-axis cylinder 67 mounted with a ball roller 68 at a tip portion of the piston rod.

When the piston rod of the Z-axis cylinder 67 equipped with ball rollers is pushed out, the friction between the mooring member 65 and the surface of the object disappears due to the separation of the mooring member 65 from the surface of the object, and thus the suction cup unit is released from its mooring state, i.e., it can move along the surface of the object.

When the piston rod of the Z-axis cylinder 67 is retracted, since the locking member 65 is strongly pressed against the surface of the object 1, the friction between the locking member 65 and the surface of the object 1 increases, so that the suction cup unit is locked to the surface of the object 1.

The cylinder case of the Z-axis cylinder 67 is fixed to the suction cup frame member 61.

For each state of the suction cup unit, the following two states can be arbitrarily selected. That is, an adsorption movable state which is adsorbed to the surface of the object 1 and is moved along the surface of the object 1, or an adsorption locked state in which it attracts to the surface of the object 1 and is locked to the surface of the object 1.

As for the planar shape of each suction cup 6, it has a shape same as each quadrangle when a roughly square was divided into four quadrangles of the same shape except the small square part of the center;

the quadrangles are formed provided with two right-angle portions in a diagonal portion;

one right angle of the two right-angle portions of each suction cup 6 overlaps with one of the four right angles of the square;

two of the sides that constitute the above right angle of the suction cup 6 overlap with two of the edges that constitute the above right angle of the square;

one of the sides that constitute another right angle of the suction cup 6 intersects to an acute angle in one side of the right angle of the square, and another side intersects to an obtuse angle in another side of the right angle of the square, wherein the angle of the acute angle is almost approximately 63 degrees.

In the device shown in FIGS. 1 to 8, the adjacent suction cup units on the X-axis are communicated with each of two pistons of two X-axis dual rod-less cylinders 4 via two Y-axis dual rod-less cylinders 5 so that each suction cup 6 can move in an arbitrary direction on the X-axis at an arbitrary time.

The adjacent suction cup units on the Y-axis are connected to each of two pistons of two Y-axis dual rod-less cylinders 5 so that each suction cup 6 can move in an arbitrary direction on the Y-axis at an arbitrary time.

It is to be noted that the dual rod-less cylinder is a general slit type rod-less cylinder provided with two piston rods, and each of the two piston rods is movable in a direction away from each other at an arbitrary time, or to move in the same direction.

The configuration of the dual rod-less cylinder in the present invention is described below.

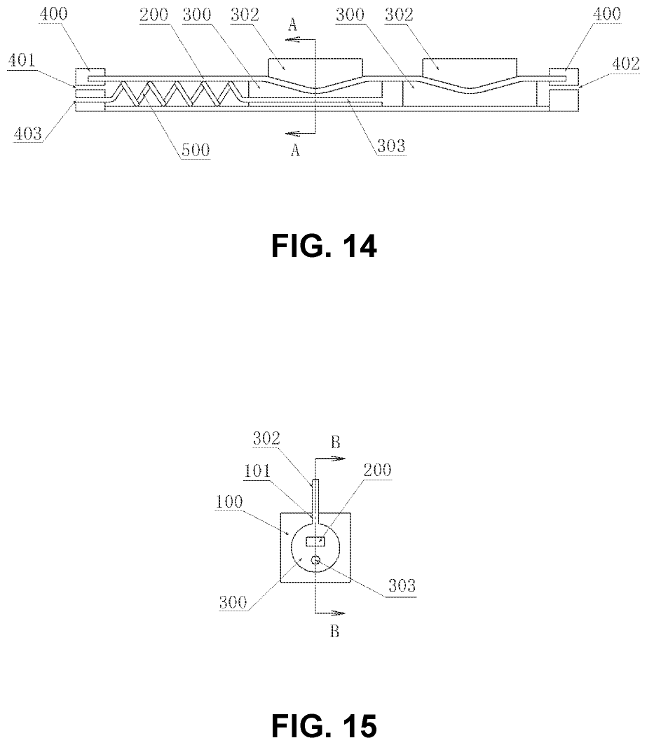

As shown in FIGS. 14 and 15, both ends of a cylinder 100 with slit 101 are blocked by end caps 400, and two pistons 300 that reciprocate within the cylinder by fluid pressure such as compressed air are disposed inside the cylinder 100.

A part of a member of the pistons 300—a through member of the piston 300—is connected to a slider 302 disposed outside the cylinder 100 through the slit 101, i.e., the pistons and the slider are integrated via the through member.

The space enclosed by the two pistons 300 and the inner wall of the cylinder 100 is connected to the intermediate fluid supply/exhaust port 403 provided in one end cap 400 via the piston through hole 303 and the coiling tube 500.

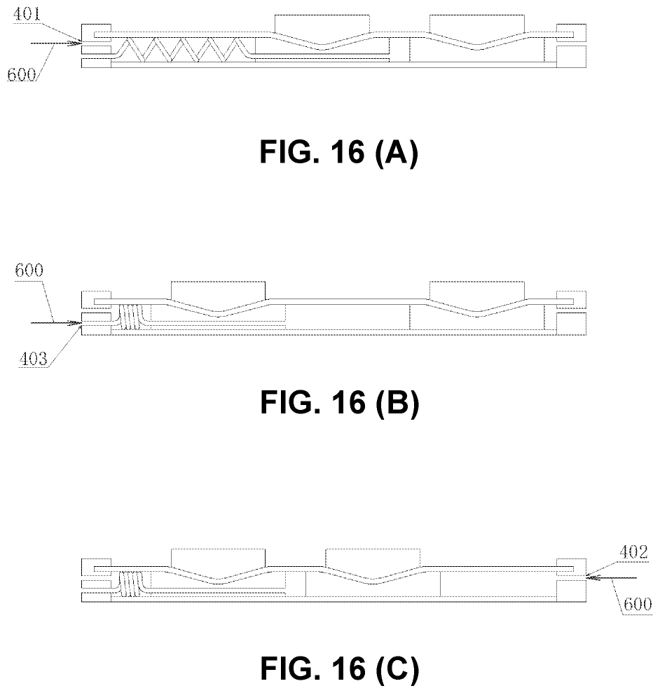

The operation of the above-described apparatus will be described below with reference to FIGS. 16(A), 16(B) and 16(C).

In FIG. 16(A), when compressed air is supplied to the left fluid supply/exhaust port 401, the compressed air passes through the coiling tube 500 and the piston through-hole 303 to reach the space surrounded by the two pistons 300 and the inner wall of the cylinder 100, and as shown in FIG. 16(B), the compressed air acts on the pistons 300 respectively, causing the two pistons 300 to move away from each other and the distance between the two pistons 300 to increase.

In FIG. 16(C), when compressed air is supplied to the right fluid supply/exhaust port 402, the compressed air acts on the right piston 300 to move it to the left in the figure. At this time, the compressed air in the space enclosed by the two pistons and the inner wall of the cylinder 100 is exhausted out of the device through the through-piston hole 303, the coiling tube 500, and the left fluid supply/exhaust port 401.

The slit-type rod-less cylinder according to the present invention described above is an example of a rod-less cylinder, and the present invention may be a magnet-type rod-less cylinder for operating the slider by utilizing the action of magnetic force by the piston.

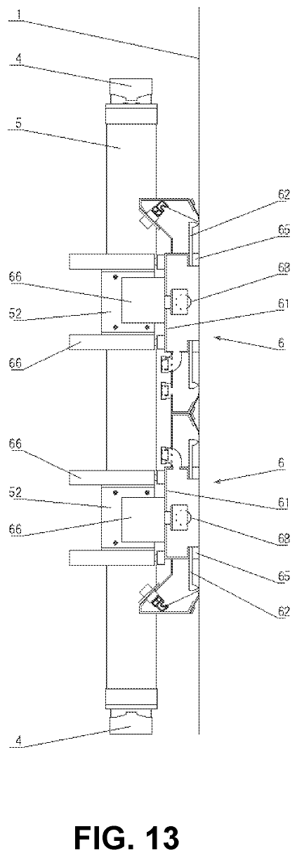

Each of the suction cup units in the device shown in FIGS. 1 to 8 is not equipped with the suction cup Z-axis protrude/retract cylinders 66 that move each suction cup 6 to the Z-axis direction intersecting the surface of the object 1, however it is easy for the suction cup 6 to be equipped with the suction cup Z-axis protrude/retract cylinders 66 as will be understood with reference to FIG. 13.

Describes a method of connecting the Z-axis cylinder 8 to each of the two pistons of the X-axis dual rod-less cylinder 4, the side surface portion of the cylinder case of the Z-axis cylinder 8 is fixed to the piston through the suction cup connecting fitting 52.

In the case wherein the Z-axis cylinder 8 is provided in the device, the adjacent suction cup units on the X-axis are connected to each of the two pistons of two X-axis dual rod-less cylinders 4, via each Z-axis cylinder 8 and each of two Y-axis dual rod-less cylinders 5, so that each suction cup 6 can move in an arbitrary direction on the X-axis at an arbitrary time.

The adjacent suction cup units on the Y-axis are connected to each of the two pistons of two Y-axis dual rod-less cylinders 5, via each Z-axis cylinder 8 and each of two Y-axis dual rod-less cylinders 5, so that each suction cup 6 can move in an arbitrary direction on the Y-axis at an arbitrary time.

Describes below the effect of the case where the Z-axis moving cylinder 8 is provided in the device, the device of the present invention can step over the window glass frame in addition to that the device can adhere to the surface 1 and travel on the surface 1 in either of the X-axis direction or the Y-axis direction.

In addition, the use of dual rod-less cylinders in the suction-adhering and self-propelled robotic device has the advantage of requiring only half the number of cylinders compared to the conventional slit-type single rod-less cylinder, simplifying the structure of the system, making it lighter, smaller, and reducing the manufacturing cost of the system.

In the suction-adhering and self-propelled robotic device of the present invention, the device is equipped with the suction cup Z-axis protrude/retract actuators for moving each of the suction cup 6 in the Z-axis direction crossing the surface of the object 1, so that the suction cup 6 has a function of separating the suction cup 6 from the surface of the object 1 when the suction cup 6 is needed to be set apart from the surface of the object 1.

The device shown in FIG. 13 comprises the suction cup Z-axis protrude/retract actuator which moves each suction cup unit in a direction generally orthogonal to the surface of the object 1. That is, the device has a function of separating the suction cup 6 from the surface of the object 1 at an arbitrary time.

For each state of the suction cup unit, the following three states can be arbitrarily selected. That is, an adsorption movable state which is adsorbed to the surface of the object 1 and is moved along the surface of the object 1, or an adsorption locked state in which it attracts to the surface of the object 1 and is locked to the surface of the object 1, or a non-adsorptive movable state which is not adsorbed to the surface of the object 1 and is moved along the surface of the object 1.

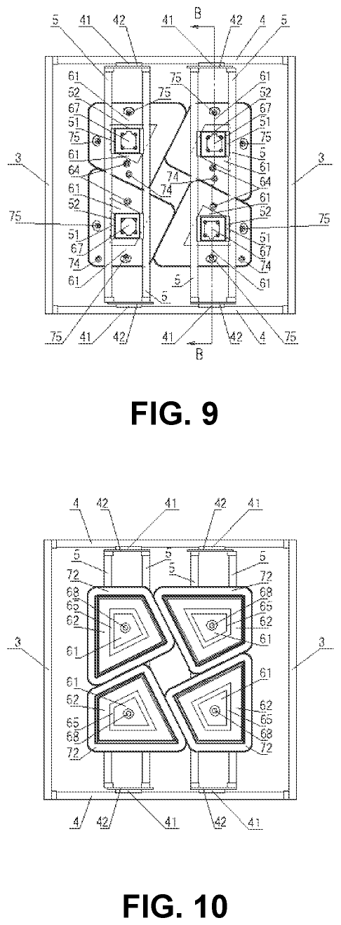

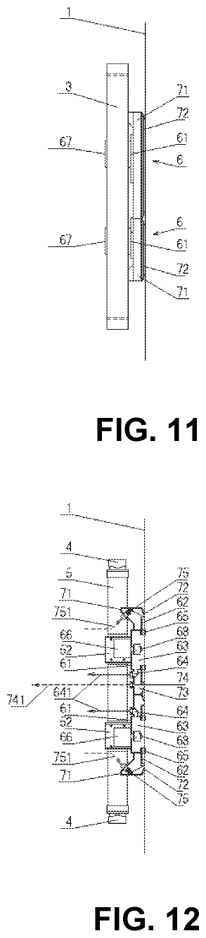

Describes in detail the device according to the second embodiment of the present invention with reference to FIGS. 9 to 12, comprising:

a second suction cup is provided at the outer peripheral portion of each suction cup 6;

the second suction cup is comprised of a second suction cup frame member 61 connected to the outer peripheral portion of the suction cup frame member 61 of the suction cup 6 and a second suction cup seal member 62 attached to the outer peripheral portion of the second suction cup frame member 61;

it is formed the second negative pressure space surrounded by the suction disk frame member 61, the suction disk seal member 62, the second suction cup frame member 61, the second suction cup seal member 62 and the surface of the object 1, it is communicated with the second negative pressure space the second fluid extraction mechanism for extracting fluid from the space, it is equipped with the second negative pressure space the fluid ejecting nozzle for ejecting the fluid such as water or cleaning agent toward the surface of the object 1.

In the device shown in FIGS. 9 to 12 described above; the surface of the object 1, the suction cup frame member 61, the suction cup seal member 62, the second suction cup frame member 61, and the second suction cup seal member 62 cooperate to define the second negative pressure space 73.

The second negative pressure space 73 is communicated with the second suction generating means.

In the second negative pressure space 73, an injection port of a water spray nozzle 75 for spraying washing water toward the surface of the object 1 is opened. When the cleaning operation of the surface of the object 1 is started, the water is sprayed toward the surface of the object 1 which is located just in front of the movement direction of the suction cup seal member 62.

The water spray nozzle 75 is connected to a water pressure pump (not shown) via a water pressure feed hose 751.

In the cleaning operation, the dirt and water separated from the surface of the object 1 by the scraping-off action of the free end portion of the suction cup seal member 62 are removed by the action of a vacuum pump (not shown) connected to the second suction hose 741 in the direction of the arrow, and is recovered by suction.

With this configuration, it is possible to clean the surface of the object 1 without polluting the environment.

The operation of the device of the embodiment of the present invention will be described below.

When the surface of the object 1 such as a window glass of a building is to be cleaned, the suction cup 6 provided in the suction-adhering and self-propelled robotic device 2 is communicated with a suction generating means (not shown) so that the suction cup 6 is suction-adhering to the surface of the object 1.

FIGS. 1 and 3 to 5 show a state in which the device according to the embodiment of the present invention is suction-adhering to the surface of the object 1.

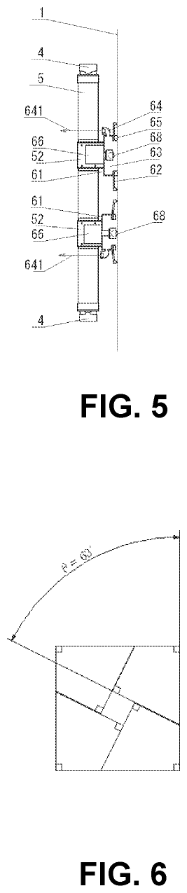

In FIG. 4, the upper and lower ball rollers 68 are retracted, and in FIG. 5, the lower ball roller 68 protrudes.

In FIG. 5, when the distance between the two piston rods of the Y-axis dual rod-less cylinder 5 is increased, the lower suction cup 6 moves downward while suction-adhering to the surface of the object 1, due to the phenomenon that the frictional force between the upper suction cup 6 and the surface of the object 1 is great and the frictional force between the lower suction cup 6 and the surface of the object 1 is small, and at the same time, a cleaning operation is performed on the surface of the object 1.

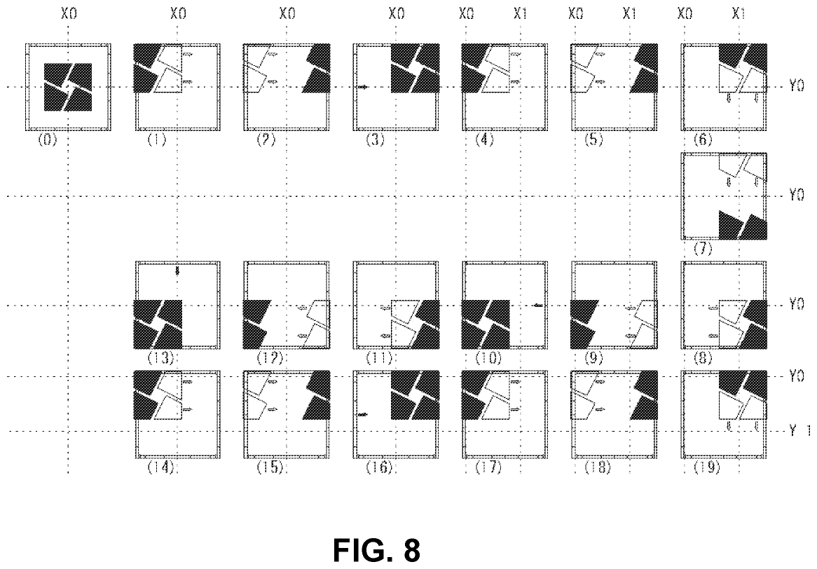

FIG. 8 illustrates a schematic view and illustrates a time-series sequential configuration of four suction cup units in which a suction-adhering self-propelling robotic device of the present invention cleans the surface of the object while suction-adhering to the surface of the object and moving from left to right, then moving from right to left, then moving from right to left, then moving from top to bottom, then from left to right, and then moving from left to right.

In FIG. 8, the procedure of the suction-adhering and self-propelled time series or the embodiment of the time series order of the four suction cup units is shown by (0) to (19).

In FIG. 8, the white arrow indicates the direction in which the suction cup, indicated by a white square, which is unlocked by the protrusion of the ball roller, moves from there.

The black arrow indicates the direction in which the outer frame of the suction-adhering self-propelled robotic device moves from this position. The suction cup units with the ball rollers retracted and locked are shown as squares painted black.

As understood from FIG. 8, the suction-adhering and self-propelled robotic device 2 of the present invention performs cleaning on the surface of the object 1 while moving along the surface of the object 1 from top to bottom as a whole by repeating the procedures (1) to (14) in FIG. 8.

Referring to FIG. 8 below, the operation of the suction-adhering and self-propelled robotic device 2 of the present invention cleaning against the surface of the object 1 while moving along the surface of the object 1 will be explained in more detail.

As shown in (1) of FIG. 8, the two suction cup units are arranged in the Y-axis, of which color are white and rectangular in shape, and the suction cup units are released from the locked state by the protrusion of the ball rollers, and then move in the direction indicated by the white arrow (to the right), and then when the suction cup units reach the predetermined position (in (2) of FIG. 8), the ball rollers retract and the units become locked. In (2) of FIG. 8, the locked state is the state where the two suction cup units on the right side turn black.

As shown in (2) of FIG. 8, the other two suction cup units are arranged in the Y-axis, of which color are white and rectangular in shape, and the suction cup units are released from the locked state by the protrusion of the ball rollers, and then move in the direction indicated by the white arrow (to the right), and then when the two suction cup units on the Y-axis and the other two suction cup units on the other Y-axis form a single, rectangular shape, the ball rollers retract and the units become locked. In (3) of FIG. 8, the locked state is the state where the four suction cup units on the right side turn black.

The outer frame of the suction-adhering and self-propelled robotic device is moved along the X-axis in the direction indicated by the black arrow (rightward) shown in (3) of FIG. 8 to the other two suction cup units locked and located in the other Y-axis, thus, as shown in (4) of FIG. 8, the outer frame is brought to the side of the two suction cup units located in the other Y-axis.

As shown in (4) of FIG. 8, as in the case of (1) of FIG. 8, the two suction cup units are arranged in the Y-axis, of which color are white and rectangular in shape, and the suction cup units are released from the locked state by the protrusion of the ball rollers, and then move in the direction indicated by the white arrow (to the right), and then when the suction cup units reach the predetermined position (in (5) of FIG. 8), the ball rollers retract and the units become locked. In (5) of FIG. 8, the locked state is the state where the two suction cup units on the right side turn black.

As shown in (5) of FIG. 8, as in the case of (2) of FIG. 8, the other two suction cup units are arranged in the Y-axis, of which color are white and rectangular in shape, and the suction cup units are released from the locked state by the protrusion of the ball rollers, and then move in the direction indicated by the white arrow (to the right), and then when the two suction cup units on the Y-axis and the other two suction cup units on the other Y-axis form a single, rectangular shape, the ball rollers retract and the units become locked.

As shown in (6) of FIG. 8, the two suction cup units are arranged in the X-axis, of which color are white and rectangular in shape, and the suction cup units are released from the locked state by the protrusion of the ball rollers, and then move in the direction indicated by the white arrow (in downward) along the Y-axis, and then when the suction cup units reach the predetermined position (in (7) of FIG. 8), the ball rollers retract and the units become locked.

As shown in (7) of FIG. 8, the other two suction cup units are arranged in the X-axis, of which color are white and rectangular in shape, and the suction cup units are released from the locked state by the protrusion of the ball rollers, and then move in the direction indicated by the white arrow (in downward) along the Y-axis, and then when the two suction cup units on the X-axis and the other two suction cup units on the other X-axis form a single, rectangular shape, the ball rollers retract and the units become locked (not shown.).

As shown in (8) of FIG. 8, the two suction cup units are arranged in the other Y-axis, of which color are white and rectangular in shape, and the suction cup units are released from the locked state by the protrusion of the ball rollers, and then move in the direction indicated by the white arrow (to the left) along the X-axis and in the opposite direction of the operation (1) of FIG. 8, and then when the suction cup units reach the predetermined position (in (9) of FIG. 8), the ball rollers retract and the units become locked.

As shown in (9) of FIG. 8, the two suction cup units are arranged in the Y-axis, of which color are white and rectangular in shape, and the suction cup units are released from the locked state by the protrusion of the ball rollers, and then move in the direction indicated by the white arrow (to the left) along the X-axis and in the opposite direction of the operation (2) of FIG. 8, and then when the two suction cup units on the Y-axis and the other two suction cup units form a single, rectangular shape, the ball rollers retract and the units become locked. In (10) of FIG. 8, the locked state is the state where the four suction cup units turn black.

The outer frame of the suction-adhering and self-propelled robotic device is moved along the X-axis in the direction indicated by the black arrow (leftward) shown in (10) of FIG. 8 to the two suction cup units locked and located in the Y-axis, thus, as shown in (11) of FIG. 8, the outer frame is brought to the side of the two suction cup units located in the Y-axis.

As shown in (11) of FIG. 8, the two suction cup units are arranged in the other Y-axis, of which color are white and rectangular in shape, and the suction cup units are released from the locked state by the protrusion of the ball rollers, and then move in the direction indicated by the white arrow (to the left) along the X-axis and in the opposite direction of the operation (4) of FIG. 8, and then when the suction cup units reach the predetermined position (in (12) of FIG. 8), the ball rollers retract and the units become locked. In (12) of FIG. 8, the locked state is the state where the two suction cup units on the left side turn black.

As shown in (12) of FIG. 8, the two suction cup units are arranged in the Y-axis, of which color are white and rectangular in shape, and the suction cup units are released from the locked state by the protrusion of the ball rollers, and then move in the direction indicated by the white arrow (to the left) along the X-axis and in the opposite direction of the operation (5) of FIG. 8, and then when the two suction cup units on the Y-axis and the other two suction cup units on the other Y-axis form a single, rectangular shape, the ball rollers retract and the units become locked. In (13) of FIG. 8, the locked state is the state where the four suction cup units turn black.

The outer frame of the suction-adhering and self-propelled robotic device is moved along the Y-axis in the direction indicated by the black arrow (downward) shown in (13) of FIG. 8 toward the four suction cup units locked and arranged to form a single rectangular shape, thus, the relative position of the outer frame and the four suction cup units changes to the relative position shown in (14) of FIG. 8.

In the following, the procedure (1) in FIG. 8 is repeated again to clean the surface of the object.

The cleaning process described in the description section of the embodiments of the present invention may be realized as a computer program.

For example, an embodiment of the present invention may be realized as a computer program product, including a computer program, recorded on a computer readable recording medium.

The computer system may be equipped with a central processing unit (CPU), which is capable of executing various appropriate operations and processes based on a program stored in a read-only memory (ROM) or loaded into a random access memory (RAM) from a storage unit.

The RAM further stores various programs and data necessary for the operation of the computer system.

The computer program, when executed by the central processing unit (CPU), realizes the above cleaning process of the present invention.

The suction-adhering and self-propelled robotic device achieves the advantageous effect of scraping off the dirt and water cleanly without leaving any residue, as the four suction cup units are arranged to form a single short square.

While the preferred embodiments of the device constructed in accordance with the present invention have been described in detail with reference to the attached drawings, it is not intended that the invention be limited to such embodiments and that various changes or modifications may be made therein without departing from the scope of the invention.

The present invention can be applied to various structures as a device for performing various types of work such as cleaning and inspection work safely and efficiently by remote control on the surface of objects of structures, etc. In particular, the present invention can be effectively applied to cleaning works of buildings having glass windows on all outer wall surfaces and buildings having large inner wall surfaces made of glass.

What is claimed is:

1. A suction-adhering and self-propelled robotic device that can adhere to the flat or curved surface of the object by negative-pressure suction and that can travel in the Y-axis direction and the X-axis direction, comprising:
at least four suction cup units that are arranged in two rows with two units in a row respectively, Y-axis actuators that move each suction cup unit to the Y-axis direction and X-axis actuators that move each suction cup unit to the X-axis direction;
a suction cup, a frictional force adjustment mechanism that is equipped with the suction cup in order to decrease or to increase the friction between the suction cup and the surface of the object, and a fluid extraction means that is communicated with a first negative-pressure space and extracts the fluid from the first negative-pressure space that is surrounded by the suction cup and the surface of the object;
each of the Y-axis actuator and the X-axis actuator consists of the rod-less cylinder, and is sealed at both ends with end caps, and inside the cylinder are two pistons that move back and forth inside the cylinder by fluid pressure;
the space enclosed by the two pistons and the inner wall of the cylinder is connected to the ports for supply and exhaust on the end cap via coiling tubes located in the cylinder.

2. The suction-adhering and self-propelled robotic device according to claim 1, wherein the device is equipped with the suction cup Z-axis protrude/retract actuators that move each suction cup unit to the Z-axis direction intersecting the surface of the object when the suction cup is needed to be set apart from the surface of the object.

3. The suction-adhering and self-propelled robotic device according to claim 1, wherein a second suction cup is formed at the outer peripheral portion of each suction cup, wherein the second suction cup is comprised of a second suction cup frame member fixed at the outer peripheral portion of the suction cup frame member, wherein the second suction cup is also comprised of a second vacuum sealing member that is put on in the outer peripheral portion of the second suction cup frame member, wherein it is formed the second negative-pressure space that is surrounded by the suction cup frame member, the vacuum sealing member, the second suction cup frame member, the second vacuum sealing member and the surface of the object, wherein the second negative-pressure space is communicated with a second fluid extraction means that extracts the fluid from the second negative-pressure space, wherein a fluid jetting nozzle is equipped with the second negative-pressure space, wherein the fluid such as water or cleaning agent is ejected toward the surface of the object from the fluid jetting nozzle.

4. The suction-adhering and self-propelled robotic device according to claim 1, wherein the surface of the object is window glass, and the fluid injected from the fluid injection nozzle is water or a cleaning agent.

5. A suction-adhering and self-propelled robotic device that can adhere to the flat or curved surface of the object by negative-pressure suction and that can travel in the Y-axis direction and the X-axis direction, comprising:
at least four suction cup units that are arranged in two rows with two units in a row respectively, Y-axis actuators that move each suction cup unit to the Y-axis direction and X-axis actuators that move each suction cup unit to the X-axis direction;
each of the Y-axis actuator and the X-axis actuator consists of the rod-less cylinder, and is sealed at both ends with end caps, and inside the cylinder are two pistons that move back and forth inside the cylinder by fluid pressure;
The space enclosed by the two pistons and the inner wall of the cylinder is connected to the ports for supply and exhaust on the end cap via coiling tubes located in the cylinder;
the suction cup unit is equipped with a suction cup, a frictional force adjustment mechanism that is equipped with the suction cup in order to decrease or to increase the friction between the suction cup and the surface of the object;
the suction cup is comprised of a suction cup frame member and a vacuum sealing member that is put on in the outer peripheral portion of the suction cup frame member;
each of the suction cup units has an abbreviated flat shape and a rectangular shape, with two approximately right-angled corners on one diagonal, and acute and obtuse corners on the other diagonal, and the four suction cup units are arranged to form one abbreviated square;
the robotic device is equipped with a cleaning process, comprising:
step 1 is a cleaning process in which two suction cup units arranged in the Y-axis are released from their locked state and moved along the X-axis, and when they reach a predetermined position, the two suction cup units are put into their locked state;
step 2 is a cleaning process in which the two suction cup units located on the other Y-axis are released from their locked state and moved along the X-axis, and when the two suction cup units located on the Y-axis and the two suction cup units located on the other Y-axis form a single square, the two suction cup units are put into their locked state;
step 3 is a cleaning process in which the outer frame of the suction-adhering and self-propelled robotic device is moved along the X-axis to the two suction cup units in the locked state located in the other Y-axis;
the suction-adhering and self-propelled robotic device can perform a cleaning process that includes the three cleaning processes described above, namely step 1, step 2, and step 3.

6. The suction-adhering and self-propelled robotic device according to claim 5, wherein the cleaning process further comprises:
step 4 is a cleaning process in which two suction cup units arranged in the X-axis are moved along the Y-axis with the suction cup units released from their locked state, and when they reach a predetermined position, the two suction cup units are put into their locked state;
step 5 is a cleaning process in which the two suction cup units located on the other X-axis are released from their locked state and moved along the Y-axis, and when the two suction cup units located on the Y-axis and the two suction cup units located on the other Y-axis form a single square, the two suction cup units are put into their locked state;
step 6 is a cleaning process in which the outer frame of the suction-adhering and self-propelled robot device is moved along the Y-axis to the two suction cup units in the locked state located on the other X-axis.

7. The suction-adhering and self-propelled robotic device according to claim 5, wherein each of the suction cup units is further equipped with the suction cup Z-axis protrude/retract actuator for moving the suction cup unit in the Z-axis direction intersecting the surface of the object, and is equipped with a suction cup friction force adjustment mechanism, wherein the suction cup unit is released from the locked state or is made to be locked by the Z-axis actuator being operated in the Z-axis direction.

8. The suction-adhering and self-propelled robotic device according to claim 5, wherein the robotic device is further equipped with the suction cup Z-axis protrude/retract cylinders which are provided for self-propelled movement of the robotic device in any direction along the surface of the object.

9. The suction-adhering and self-propelled robotic device according to claim 5, wherein the robotic device is further equipped with a means for collecting dirt and water peeled off from the surface of the object scraped off by the free end of the suction cup sealing member, and a second suction cup is placed on the outer periphery of each of the suction cup units to prevent the dirt and water from scattering around the robotic device.

10. The suction-adhering and self-propelled robotic device according to claim 5, wherein the robotic device is further equipped with a method of cleaning the surface of the object performed by the robotic device, the cleaning process comprise at least one or more of the cleaning processes comprising step 1, step 2, step 3, step 4, step 5, and step 6.

11. The suction-adhering and self-propelled robotic device according to claim 5, wherein the robotic device is further equipped with a computer program executed by the robotic device, which is equipped with a memory and a processor for executing the program, wherein the memory stores a computer program to perform a method for cleaning the surface of the object, including at least one or more of the cleaning processes comprising step 1, step 2, step 3, step 4, step 5, and step 6, wherein the cleaning method is realized when the program is executed by the processor.

12. The suction-adhering and self-propelled robotic device according to claim 5, wherein the robotic device is further equipped with a computer readable recording medium, wherein the medium stores a computer program to perform a method for cleaning the surface of the object, including at least one or more of the cleaning processes comprising step 1, step 2, step 3, step 4, step 5, and step 6, wherein the cleaning method is realized when the program is executed by the processor.
